(19) United States
(12) Patent Application Publication
(10) Pub. No.: US 2007/0083396 A1
(43) Pub. Date: Apr. 12, 2007

(54) Image interpretation support system

(75) Inventors: Shouji Kanada, Minato-ku (JP); Takahiro Ito, Minato-ku (JP); Yuuma Adachi, Minato-ku (JP); Yoshifumi Shioe, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/521,515

(22) Filed: Sep. 15, 2006

(30) Foreign Application Priority Data
Sep. 27, 2005 (JP) 2005-280708
Mar. 27, 2006 (JP) 2006-084951

(51) Int. Cl. G06K 9/00; G06F 19/00

(52) U.S. Cl. 705/3; 382/128

(57) ABSTRACT

An image interpretation support system by which past image interpretation results on an examination as an object of follow-up observation can be easily grasped. The system has: a server for storing a report database accumulating difference information between past reports in association with the respective past reports; and an image interpretation report creating apparatus connected thereto. The apparatus includes: a follow-up observation examination determining unit for determining whether or not this examination is an object of follow-up observation; a report finding control unit for creating an image interpretation report at this time by generating an image interpretation report creation screen and entering information in the screen; a changed portion extracting unit for extracting a changed portion to generate difference information; and a report saving unit for storing the difference information in association with the report at this time and the past report in the report database.

### BACKGROUND OF THE INVENTION

1. Field of the Invention

The present invention relates to an image interpretation support system for supporting image interpretation performed by doctors after imaging of examination images (medical images) to be used for medical diagnoses by images.

2. Description of a Related Art

Recent years, along with the spread of medical digital image generation technologies such as CR (computed radiography), MRI (magnetic resonance imaging) and CT (computed tomography), medical images obtained by examinations have been electronically managed.

Generally, when an imaging examination is performed, interpretation is performed on generated images by an image interpretation doctor and an image interpretation report, in which an interpretation result and finding are written, is created before a specific diagnosis is made to a patient by a doctor in charge. Conventionally, even when digital image data is generated, medical images printed on photographic films are used at the time of image interpretation. On the other hand, with the development of high-definition monitors (viewers), medical images displayed on the monitors are also used for image interpretation.

By the way, when follow-up observation of a lesion part is performed, it is necessary for the image interpretation doctor to refer to examination images of the past plural examinations and image interpretation reports on those examinations. In this regard, it is desirable that changed portions in the past image interpretation results can be extracted because the change of an affected part as a target of the examination can be easily grasped.

As a related technology, Japanese Patent Application Publication JP-P2001-125995A discloses a medical report system including report information input means for inputting report information, management means for associating the report information inputted by the report information input means with version information representing the version number of the report information and managing them, and output means for outputting the version information associated and managed with the report information by the management means. Further, the medical report system includes difference information acquiring means for acquiring difference information representing a difference from the last report information at each input of the report information, and the management means updates the version information based on the difference information acquired by the difference information acquiring means. Furthermore, in the medical report system, the management means associates the difference information acquired by the difference information acquiring means with the report information and manages them.

Further, Japanese Patent Application Publication JP-P2005-160661A discloses an examination management system characterized by including executed information input means for inputting executed information including information on execution contents of medical act executed on an examination and information related to a report regarding the medical act, executed information storage means for storing the executed information inputted by the executed information input means, executed information acquiring means for acquiring the executed information related to the report from the executed information storage means by using the information indicating the same examination of the same patient as a key, report comparing means for mutually comparing the plurality of reports acquired by the executed information acquiring means, and report comparison result display means for displaying a result compared by the comparing means.

In JP-P2001-125995A, differences between the text information are managed, and when there is a difference, it is determined that the finding has been changed and the version number of report text is increased. However, according to the system, the finding and changes of affected parts determined from the finding cannot be easily grasped.

Further, according to the examination management system disclosed in the JP-P2005-160661A, when there is a change in diagnosis, the user can be informed of the examination result. However, in the examination management system, when there is no change in diagnosis and the progress of medical condition is observed, the progress of lesion part cannot be indicated.

### SUMMARY OF THE INVENTION

The present invention has been achieved in view of the above-mentioned problems. A purpose of the present invention is to provide an image interpretation support system by which past image interpretation results on a certain examination as an object of follow-up observation can be easily grasped.

In order to achieve the purpose, an image interpretation support system according to one aspect of the present invention is an image interpretation support system for supporting creation of image interpretation reports based on medical images, which system comprises: (i) an image interpretation report server for storing a report database which accumulates difference information between past reports as image interpretation reports created in past on a same patient as that in this examination in association with the respective past reports; and (ii) an image interpretation report creating apparatus connected to the image interpretation report server directly or via a network, and the image interpretation report creating apparatus includes: follow-up observation examination determining means for determining whether or not this examination is an object of follow-up observation; report finding control means for creating, when this examination is an object of follow-up observation, an image interpretation report at this time by generating an image interpretation report creation screen by utilizing at least one past report and the difference information on the at least one past report accumulated in the report database to cause a display unit to display the image interpretation report creation screen and entering information in the image interpretation report creation screen according to a user's operation; changed portion extracting means for extracting a portion, which is changed between the image interpretation report creation screen in which the information is entered according to the user's operation and an image interpretation report creation screen generated by utilizing the at least one past report, to generate difference information; and report saving means for storing the difference information generated by the changed portion extracting means in association with the image interpretation report at this time and the at least one past report in the report database.

According to the present invention, the changed portions of the finding sentences among the plural image interpretation reports on the same patient as that of this examination are extracted and displayed, and therefore, it becomes easier for the user to grasp the past progress of the medical condition. By utilizing the past progress, the time required for creating the image interpretation report can be reduced, and the image interpretation report can be efficiently created.

### BRIEF DESCRIPTION OF THE DRAWINGS

FIG. 1 is a block diagram showing a constitution of an image interpretation support system according to the first embodiment of the present invention;

FIG. 2 is a schematic view showing an image interpretation report creation screen;

FIG. 3 shows a report database stored in an image interpretation report server shown in FIG. 1;

FIG. 4 is a block diagram showing a constitution of an image interpretation report creating apparatus shown in FIG. 1;

FIG. 5 is an enlarged view showing a finding entry screen shown in FIG. 2;

FIG. 6 shows a layout of examination images displayed on an image display terminal;

FIG. 7 is a diagram for explanation of a method of generating report difference information;

FIG. 8 is an enlarged view showing a report progress list shown in FIG. 2;

FIG. 9 is a schematic view showing a past report reference screen;

FIG. 10 is a block diagram showing a constitution of an image interpretation report creating apparatus according to the second embodiment of the present invention;

FIG. 11 is a schematic view showing a graph display screen;

FIG. 12 is a schematic view showing an image interpretation report creation screen; and

FIG. 13 is a schematic view showing a graph display screen.

### DESCRIPTION OF THE PREFERRED EMBODIMENTS

Hereinafter, preferred embodiments of the present invention will be explained in detail by referring to the drawings. The same reference numerals are assigned to the same component elements and the explanation thereof will be omitted.

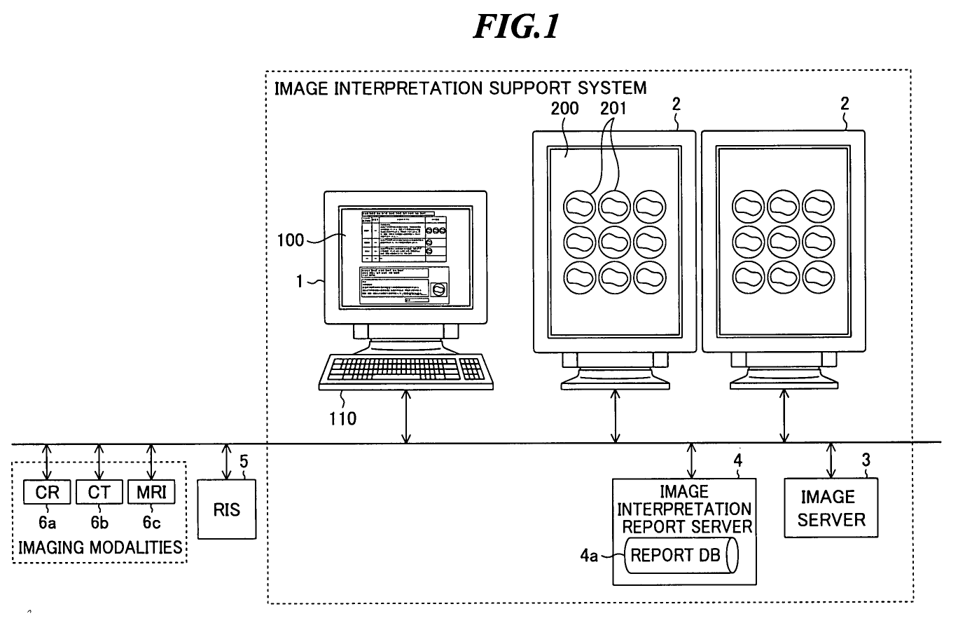

FIG. 1 is a block diagram showing a constitution of an image interpretation support system according to the first embodiment of the present invention.

As shown in FIG. 1, the image interpretation support system includes an image interpretation report creating apparatus 1, at least one image display terminal (viewer) 2, an image server 3 and an image interpretation report server 4. Further, the image interpretation support system may be connected to an RIS (radiology information system) 5 and imaging modalities such as a CR apparatus 6a, a CT apparatus 6b, and an MRI apparatus 6c. As shown in FIG. 1, these apparatuses may be connected to one another via a network such as LAN (local area network). Alternatively, the image interpretation report creating apparatus 1 and the image display terminal 2, the image server 3 and the image interpretation report server 4 may be directly connected to one another.

The image interpretation report creating apparatus 1 is an apparatus for creating image interpretation reports under a user's operation (image interpretation doctor's operation) and characterized in that, when a certain examination as a target of image interpretation is an object of follow-up observation, a change in a lesion part is grasped by referring to the image interpretation reports on examinations made in the past, and thus, the creation efficiency of the image interpretation reports is improved. In the present application, for a certain examination, one or more interpretation report on the same type of examination made on the same part of the same patient is referred to as “past report”, the examination made immediately before the certain examination is referred to as “last examination”, the most recent report among the past reports, i.e., a past report on the last examination is referred to as “last report”, and further, a past report on the examination made immediately before the last examination is referred to as “second last report”.

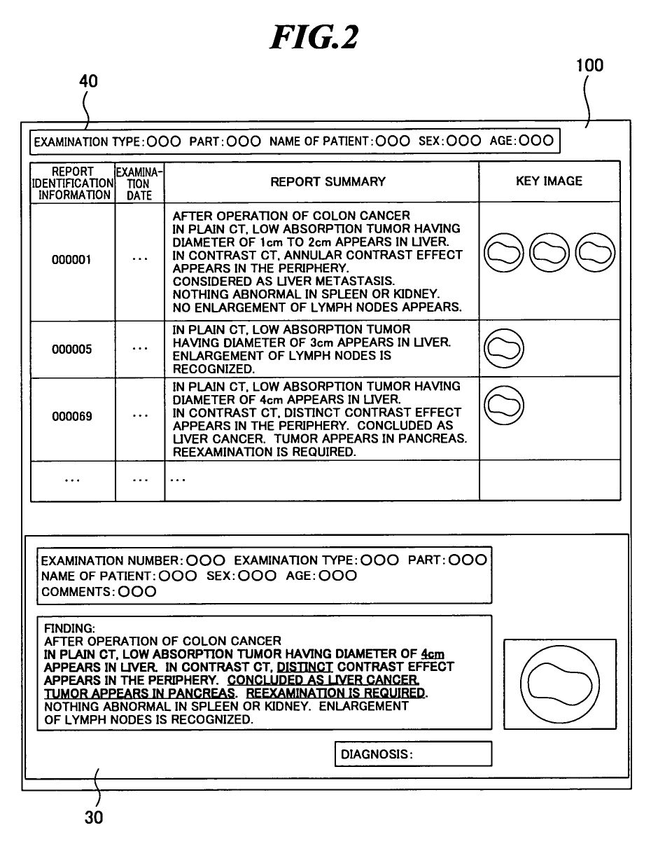

As shown in FIG. 1, the image interpretation report creating apparatus 1 has a display unit 100 and an input unit 110. The display unit 100 is a display device for displaying work lists to be used by the user for selecting an examination for which image interpretation is to be performed, an image interpretation report creation screen in which predetermined information entry columns are provided, and so on. FIG. 2 shows an image interpretation report creation screen displayed on the display unit 100. The image interpretation report creation screen contains a finding entry screen 30 for the image interpretation doctor to enter finding, and a screen of a report progress list 40 to be displayed in the case where an examination as a target of image interpretation is an object of follow-up observation. In FIG. 2, these screens 30 and 40 are displayed side-by-side, however, they may partly or entirely overlap. In this case, a screen to be displayed at the forefront can be selected according to the user's operation. By the way, in the case where the examination as a target of image interpretation is not an object of follow-up observation, the report progress list 40 may not be displayed.

The input unit 110 is an input device such as a keyboard or a mouse. The user enters information of finding text and so on by using the input unit 110 in the finding entry screen 30 shown on the display unit 100 while observing the examination images displayed on the image display terminal 2, which will be described later.

The image display terminal 2 is a terminal device for displaying an examination image as a target of image interpretation and has a high-definition display. In FIG. 1, a state is shown in which plural slice images are displayed in plural areas 201 on a screen 200, respectively. Although two image display terminals 2 are shown in FIG. 1, at least one image display terminal 2 is used at the time of image interpretation, and three or more image display terminals 2 may be used.

The image server 3 is, for example, a server for PACS (Picture Archiving and Communication System) for storing and managing image data acquired by the imaging modalities such as the CR apparatus 6a, the CT apparatus 6b and the MRI apparatus 6c. The image server 3 outputs desired image data to the image interpretation report creating apparatus 1 according to a request of the image interpretation report creating apparatus 1.

The image interpretation report server 4 includes a recording medium for storing a report database (DB) 4a. The report database 4a has accumulated report data representing image interpretation reports created in the past. The report data contains report ID, patient ID, name of patient, examination ID, text information (finding data) displayed as finding by the image interpretation doctor, and so on. Further, in the report database 4a, the report data on the same type of examination made on the same part of the same patient are managed in association with one another.

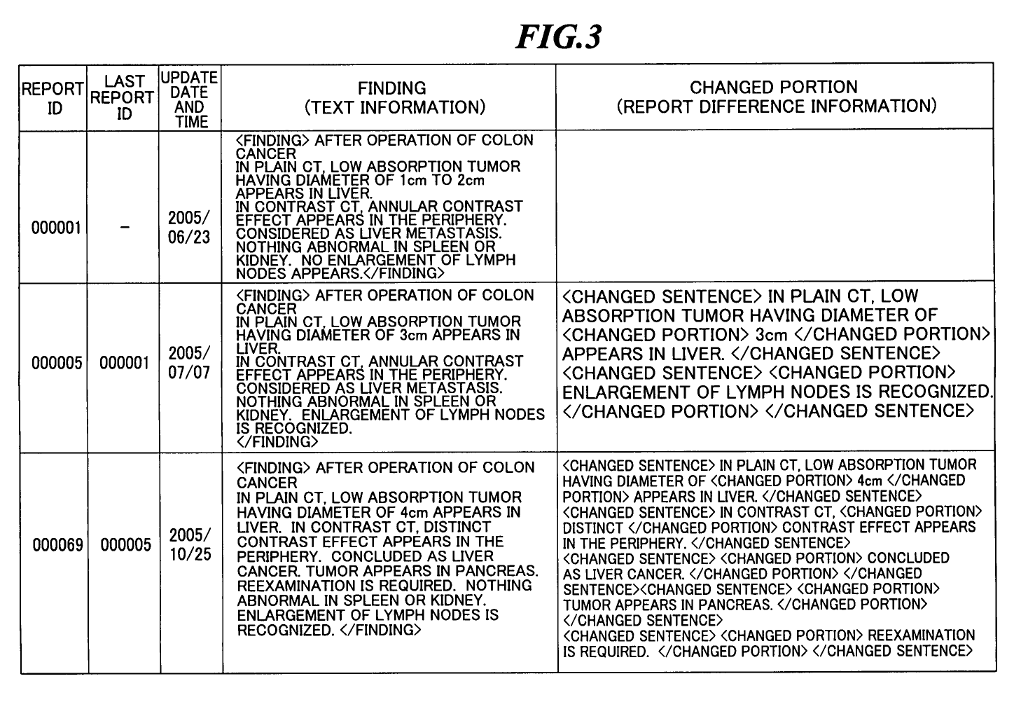

FIG. 3 shows part of report data (table) on an examination made on a certain part of a certain patient. As shown in FIG. 3, in the report database 4a, plural records containing report IDs, last report IDs, update date and time of the image interpretation report, text information representing finding, and report difference information representing changed portion are stored. The last report ID represents an ID of the last report for the image interpretation report. For example, for the image interpretation report having the report ID “000069”, the image interpretation report having the report ID “000005” corresponds to the last report. Further, the update date and time represents date and time of creation or update of image interpretation report. In the report database, plural records are accumulated in time sequence based on the date and time of update.

The text information representing finding is managed by identification tag information <FINDING> to </FINDING>. Further, the report difference information represents changed portions between the finding in the image interpretation report and the finding in the last image interpretation report thereof. The report difference information is also managed by identification tag information. That is, the changed sentence tag <CHANGED SENTENCE> to </CHANGED SENTENCE> is attached to the sentence changed from the last report (changed sentence), and the changed portion tag <CHANGED PORTION> to </CHANGED PORTION> is attached to the phrase changed in the sentence (changed portion). Alternatively, difference of information other than finding such as names of diagnoses of medical condition may be used as the report difference information.

In the report difference information of the report ID “000005” shown in FIG. 3, the changed portion tag <CHANGED PORTION> to </CHANGED PORTION> is not attached only to the changed character “3”, but the changed portion tag <CHANGED PORTION> to </CHANGED PORTION> is attached to “3 cm”. This is because the changed portion is recognized in units of words or phrases. This is the same for other words or phrases to which the changed portion tags <CHANGED PORTION> to </CHANGED PORTION> are attached. Thus, in the embodiment, the changed portions are recognized in units of words or phrases. However, the changed portions may be recognized in units of characters, or the changed portions may be recognized in consideration of dependency. When the changed portions are recognized in units of characters, in the report difference information of the report ID “000005”, the changed portion tag <CHANGED PORTION> to </CHANGED PORTION> is attached only to “3”.

Referring to FIG. 1 again, the image interpretation report server 4 outputs desired report data to the image interpretation report creating apparatus 1 according to a request therefrom.

The RIS 5 is a server for managing radiological examinations in the radiological department, and manages examination schedules, sends examination orders to the imaging modalities, and sends image interpretation orders (image interpretation requests) for examinations for which imaging has been finished, based on information such as the patient information, examination contents and so on inputted by using the input terminal. The image interpretation orders are stored in the image interpretation report server 4.

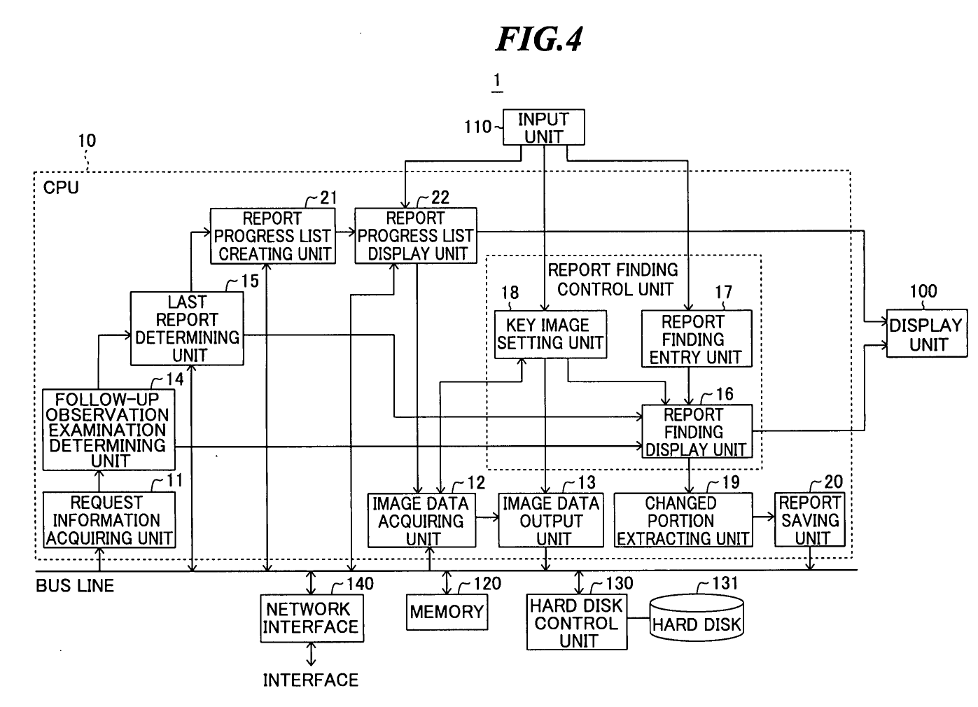

Next, a constitution and an operation of the image interpretation report creating apparatus will be explained by referring to FIGS. 1 and 4. FIG. 4 is a block diagram showing the constitution of the image interpretation report creating apparatus shown in FIG. 1. As shown in FIG. 4, the image interpretation report creating apparatus 1 includes, in addition to the display unit 100 and input unit 110 that have been explained above, a central processing unit (hereinafter, referred to as CPU) 10, a memory 120 that temporarily stores report data inputted from the image interpretation report server 4, image data inputted from the image server 3 and so on, a hard disk control unit 130 that controls a hard disk 131 as a recording medium, and a network interface 140. These are connected via a bus line to one another. Further, the CPU 10 is connected to a network via the network interface 140.

In the hard disk 131, software (program) for actuating the CPU 10 to perform processing is recorded. As the recording medium, not only the built-in hard disk 131, but also an external hard disk, a flexible disk, an MO, an MT, a RAM, a CD-ROM, a DVD-ROM or the like may be used.

Next, plural function blocks formed by the CPU 10 and software (program) will be explained. These function blocks includes a request information acquiring unit 11, an image data acquiring unit 12, an image data output unit 13, a follow-up observation examination determining unit 14, a last report determining unit 15, a report finding display unit 16, a report finding entry unit 17, a key image setting unit 18, a changed portion extracting unit 19, a report saving unit 20, a report progress list creating unit 21 and a report progress list display unit 22.

The request information acquiring unit 11 acquires image interpretation request information (also referred to as request information or order information) from the image interpretation report server 4 via the network. The request information contains information of examination ID, examination image ID, type of examination, name of patient, age and sex of patient, modality to be used, and examined part and so on. Alternatively, the request information acquiring unit 11 may acquire request information offline, or, when the image interpretation report creating apparatus is also connected to another system such as an HIS (hospital information system), the request information acquiring unit 11 may acquire request information from such a system via a network.

The image data acquiring unit 12 acquires image data for display on the image display terminal 2 from the image server 3 and outputs the data to the image data output unit 13 based on the request information. Further, the image data acquiring unit 12 outputs image data in a slice position to be used as a key image to the key image setting unit 18, which will be described later, according to the request therefrom. By the way, although the image interpretation report creating apparatus 1 acquires image data from the image server 3 online in the embodiment, the apparatus may acquire the image data offline from recording media such as DVD (digital versatile disk) or CD (compact disk).

The image data output unit 13 outputs the image data received from the image data acquiring unit 12 such that examination images are displayed on the image display terminal 2. In this regard, the image data output unit 13 sets a layout of the examination images such that plural slice images are located in plural areas 201 in the order of image number, for example.

The follow-up observation examination determining unit 14 determines whether or not an examination on which an image interpretation report is to be created is an examination as an object of follow-up observation. For example, in the case where it is determined that the same type of examination is performed within a predetermined period (e.g., within six months) on the same part of the same patient as a result of referring to the work list in the past, the examination is determined as being an object of follow-up observation. The period, within which an examination is determined as being an object of follow-up observation, may be designated by the user settings. Alternatively, in the case where an examination is clearly stated as an object of follow-up observation in the details of the request of examination and request information contains information representing that the examination is an object of follow-up observation, those examinations are also determined as being objects of follow-up observation.

Such determination may be performed at the time when the user selects an examination from the work list when performing image interpretation, at the time when new image data is stored in the image server, or at the time when request information is received from the RIS or the like.

When an examination on which an image interpretation report is to be created is determined as being an examination as an object of follow-up observation, the last report determining unit 15 determines the most recent image interpretation report (last report) on the same type of examination performed on the same part of the same patient as that in this examination from the report database 4a stored in the image interpretation report server 4.

A report finding control unit including the report finding display unit 16, the report finding entry unit 17 and the key image setting unit 18 creates the finding entry screen 30 to cause the display unit 100 to display it, and edits the text information representing finding based on the information inputted by the user and creates an image interpretation report.

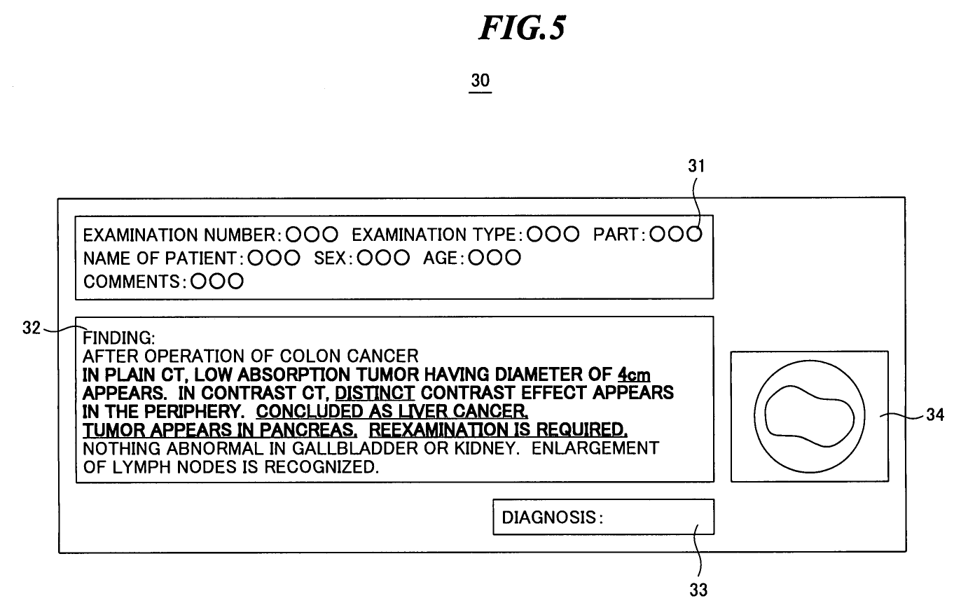

FIG. 5 is an enlarged view of the finding entry screen 30 shown in FIG. 2. The finding entry screen 30 contains an examination information display column 31, a finding entry column 32, a diagnostic outcome entry column 33 and a key image display column 34. The examination information display column 31 is an area for displaying an examination number as information required for identifying the examination, a type of examination (examination type), a part as a target of examination, a name, sex and age of a patient, comments on the examination and so on. The report finding display unit 16 receives such information from the image interpretation report server 4 based on the request information, and displays it in the examination information display column 31.

The finding entry column 32 is an area where finding is entered by the image interpretation doctor. In order to create the finding entry column 32, the report finding display unit 16 first acquires information on the last report determined in the last report determining unit 15 from the report database 4a shown in FIG. 3. Then, the unit copies the finding of the last report and attaches it to the finding entry column 32. Furthermore, the report finding display unit 16 sets a format of the finding attached to the finding entry column 32 based on the report difference information of the last report (i.e., portions changed from the second last report). Specifically, when this examination is the fourth time, the finding on the third examination is displayed in the finding entry column 32 and a predetermined format is set for the changed portions between the second finding and the third finding.

As the format set for the finding, for example, the changed sentences within the report difference information are indicated by boldface (sentences of “IN PLAIN CT, . . . APPEARS IN LIVER.”, “IN CONTRAST CT, . . . IN THE PERIPHERY.”, “CONCLUDED AS LIVER CANCER.”, “TUMOR APPEARS IN PANCREAS”, and “REEXAMINATION IS REQUIRED.”), and the changed portions in the sentences are underlined (the portions of “4 cm”, “DISTINCT”, “CONCLUDED AS LIVER CANCER.”, “TUMOR APPEARS IN PANCREAS.”, and “REEXAMINATION IS REQUIRED.”). Alternatively, the color of characters in the changed sentences and changed portions may be altered.

Thus displayed finding in the finding entry column 32 is used as a draft of the image interpretation report to be created at this time. The report finding entry unit 17 rewrites the draft according to the user's operation, and thereby, the finding in the image interpretation report at this time is created.

By the way, when the examination as a target of image interpretation is the first examination or not an object of follow-up observation, the report finding display unit 16 displays a blank finding entry column 32.

The diagnostic outcome entry column 33 is an area where a diagnosis by the image interpretation doctor is entered. The report finding entry unit 17 inputs text information representing the diagnostic outcome into the diagnostic outcome entry column 33 according to the user's operation.

The key image display column 34 is an area for displaying an image (key image) determined by the image interpretation doctor as being a key of image interpretation among a series of images obtained by one examination. At least one key image is set for one examination. As the key image, a slice image in which a lesion part is recognizably shown, a slice image in which an especially notable part is shown, or a slice image determined as being suitable for image interpretation is selected.

The key image setting unit 18 shown in FIG. 4 displays the key image in the last report determined by the last report determining unit 15 in the key image display column 34. Further, in the process of creating the image interpretation report at this time, when the key image is determined by the image interpretation doctor, the key image setting unit 18 acquires image data representing the slice image as the key image from the image data acquiring unit 12, converts the data into a general-purpose image format such as a JPEG format or a bitmap format, and display it in the key image display column 34.

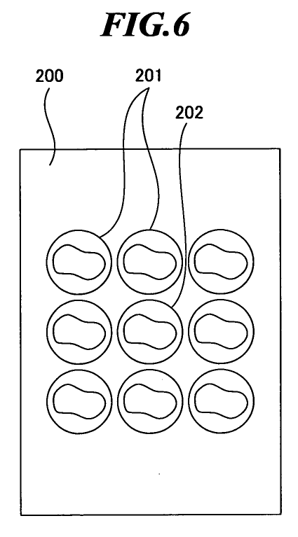

Further, the key image setting unit 18 may set a link between the key image displayed in the key image display column 34 and the examination images displayed on the image display terminal 2 (FIG. 1). When the link is set, the key image setting unit 18 allows the image data output unit 13 to set the layout of the examination images according to the user's operation of selecting the key image by clicking it with the mouse or the like. For example, as shown in FIG. 6, the key image is located in the area 202 at the center of the screen 200.

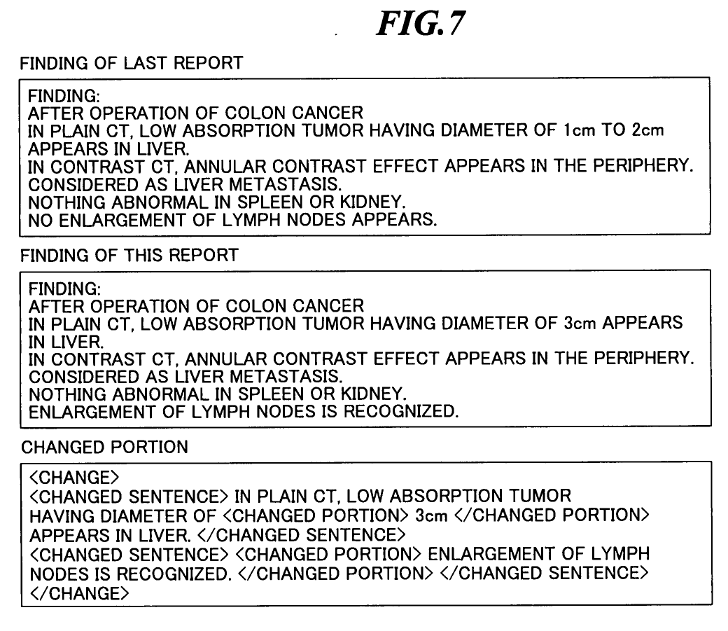

When a save command of finding data is inputted or an end command of finding entry is inputted by the user, the changed portion extracting unit 19 generates report difference information by extracting changed portions between the text information of the finding in the last report and the text information of the finding in the image interpretation report created at this time (this report). For example, as shown in FIG. 7, in comparison between the finding of the last report and the finding of this report, in the sentence “IN PLAIN CT, . . . APPEARS IN LIVER”, the portion of the diameter is different between “1 cm TO 2 cm” and “3 cm”. Accordingly, the changed portion extracting unit 19 attaches the changed sentence tag (<CHANGED SENTENCE> to </CHANGED SENTENCE>) to the sentence “IN PLAIN CT, . . . APPEARS IN LIVER”, the changed portion tag (<CHANGED PORTION> to </CHANGED PORTION>) to the portion “3 cm”, attaches the change tag (<CHANGE> to </CHANGE>) to the entire of them, and saves the information. By the change tag, the changed portion in this finding can be recognized.

Alternatively, the changed portion extracting unit 19 may save the edit operation history in the report finding entry unit 17 and extract the changed text information based on the edit operation history so as to generate report difference information.

Furthermore, the changed portion extracting unit 19 may extract, as report difference information, changed portions in request information, diagnostic information (e.g., information displayed in the diagnostic outcome entry column 33 shown in FIG. 5), note information (e.g., comments displayed in the examination information display column 31 shown in FIG. 5) and so on.

When a save command of finding data is inputted or an end command of finding entry is inputted by the user, the report saving unit 20 generates report data representing this report containing the edited finding, associates the report difference information generated by the changed portion extracting unit 19, this report and the last report with one another, and stores them in the report database 4a (FIG. 1).

Further, the report saving unit 20 does not save this report when the report difference information is not generated by the changed portion extracting unit 19 (i.e., when there is no changed portion). That is, the finding unedited from the draft is not saved.

When the examination as a target of image interpretation is determined as being an object of follow-up observation by the follow-up observation examination determining unit 14, the report progress list creating unit 21 creates a report progress list that indicates the progress of the examination based on the report database 4a shown in FIG. 3.

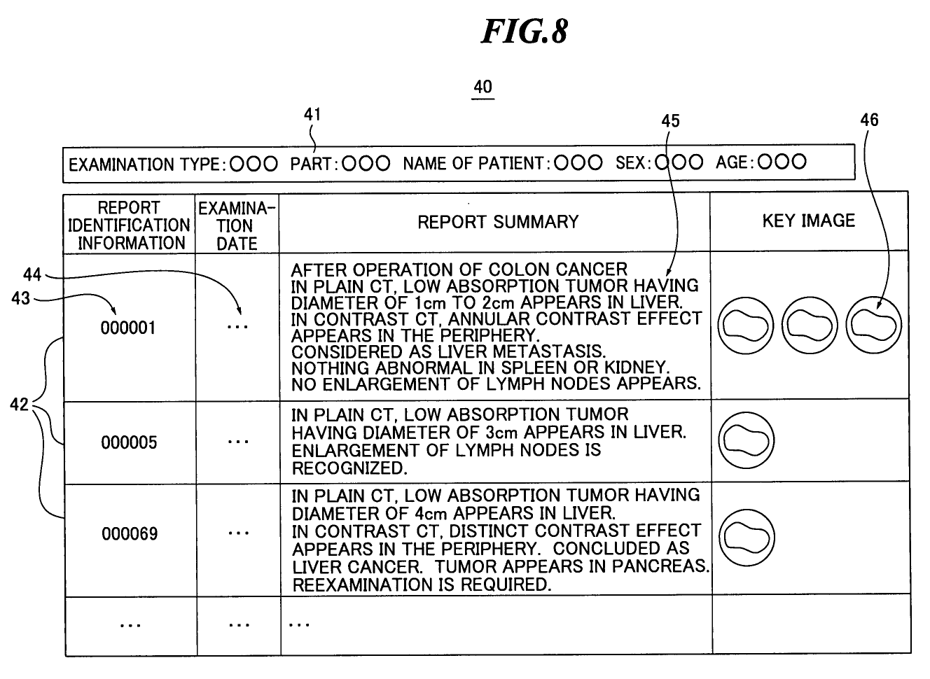

FIG. 8 is an enlarged view of a report progress list 40 shown in FIG. 2. As shown in FIG. 8, the report progress list 40 contains a patient information display column 41 and plural progress information display columns 42 located in the order of examination date. The patient information display column 41 is an area for displaying information required for identifying examinations and patients such as an examination type, an examination part, a name, sex and age of a patient.

In each progress information display column 42, report identification information 43 for identifying the image interpretation report created in the past (past report), examination date information 44, a report summary 45 as a summary of finding in the past report and a key image 46 are displayed.

The report progress list creating unit 21 shown in FIG. 4 copies the report difference information stored in the report database 4a shown in FIG. 3 and attaches it to the progress information display column 42 as the report summary 45. That is, the report summary 45 represents the sentences changed between the last report and the second last report with respect to a certain examination. The report progress list creating unit 21 may set a link between the report summary 45 and the past image interpretation report.

Further, the report progress list creating unit 21 copies the key image stored in the report database 4a shown in FIG. 3 and attaches it to the progress information display column 42 as the key image 46. The report progress list creating unit 21 may set a link between the key image 46 and the examination image stored in the image server.

The report progress list display unit 22 allows the display unit 100 to display the report progress list created in the report progress list creating unit 21.

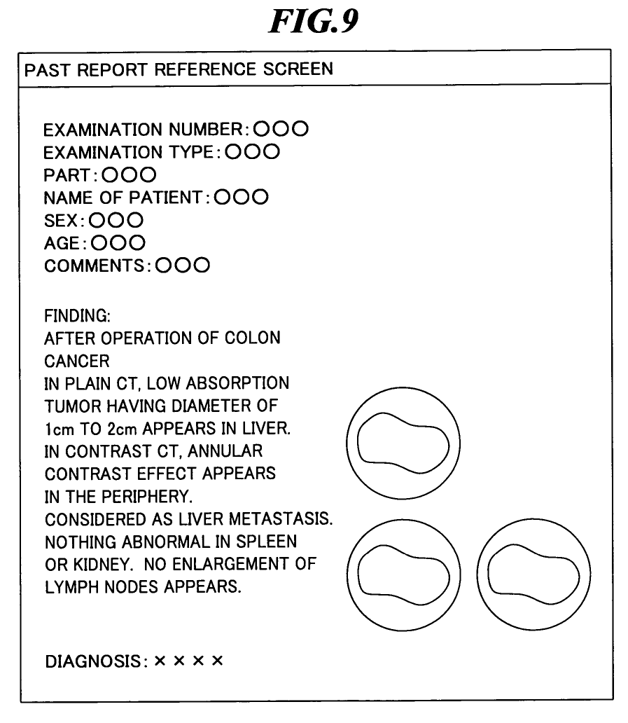

Further, as shown in FIG. 9, the report progress list display unit 22 allows the display unit 100 to display the full text of the past report on the report summary according to the user's operation of selecting the key image by clicking it with the mouse or the like. Furthermore, the report progress list display unit 22 lays out the past examination images containing the key image in the order of image number such that the key image is located in the center area 202 as shown in FIG. 6 by controlling the image data acquiring unit 12 according to the user's operation of selecting the key image 46 by clicking it with the mouse or the like, and displays the images on the image display terminal 2.

Next, the creation of image interpretation report utilizing the image interpretation support system according to the embodiment will be explained.

The image interpretation report creating apparatus 1 shown in FIG. 1 starts the operation when receiving request information via the network, and displays the image interpretation report creation screen shown in FIG. 2 on the display unit 100. Alternatively, the image interpretation report creating apparatus 1 may display the work list on the display unit 100 when the user logs in, and display the report creation screen on the examination selected from the work list by the user. As described above, the report progress list 40 shows the digest of past reports in time sequence. Accordingly, when the creation of image interpretation is started, the report progress list 40 is automatically displayed, and thereby, the user can easily grasp the changes in past findings on the patient, i.e., the lesion progress, and use it for the diagnosis at this time.

The user rewrites the draft displayed on the finding entry screen 30 while referring to the report progress list, and creates the finding at this time. Thus, since the draft is shown, even the image interpretation doctor inexperienced to finding entry can create the image interpretation report easily.

After finishing the finding entry, the user inputs a save command of the image interpretation report. Thereby, the difference information between the finding text at this time and the finding text at the previous time is extracted, associated with the image interpretation reports at this time and at the previous time, and stored in the format shown in FIG. 3 in the report database 4a (FIG. 1). The difference information is used for displaying the report progress list and the draft of the finding text when the next examination is performed on the same patient and an image interpretation report thereof is created. Further, the draft is prevented from being incorrectly saved without change because the image interpretation including the unedited finding text cannot be saved.

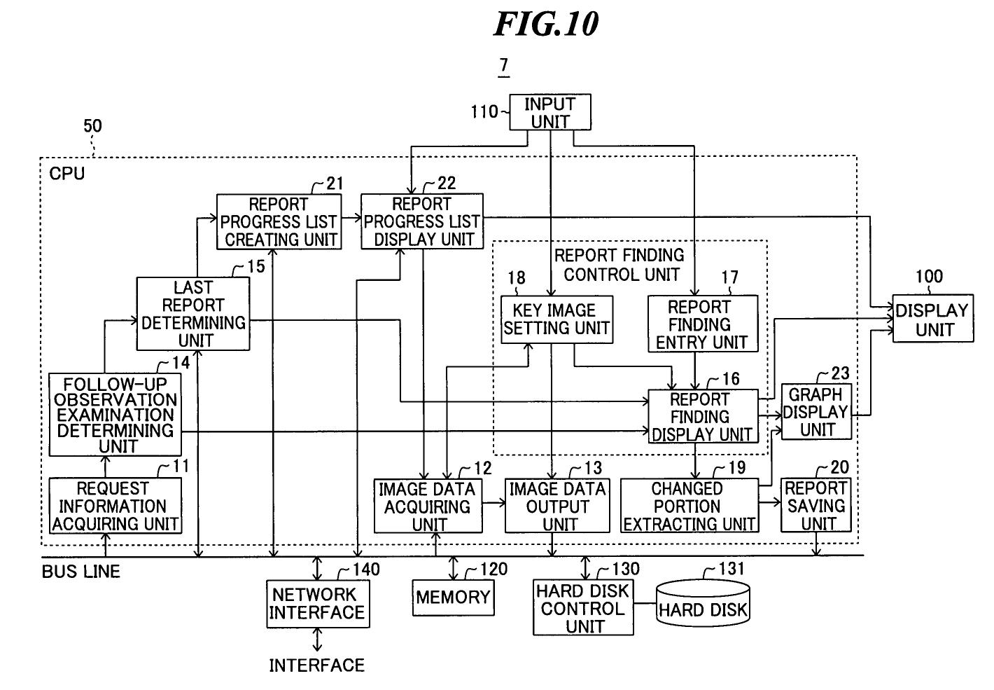

Next, an image interpretation support system according to the second embodiment of the present invention will be explained. The constitution of the image interpretation support system according to the embodiment is nearly the same as the constitution of the image interpretation support system according to the first embodiment (FIG. 1) as described above, and includes an image interpretation report creating apparatus 7 shown in FIG. 10 in place of the image interpretation report creating apparatus 1.

As shown in FIG. 10, the image interpretation report creating apparatus 7 further includes a graph display unit 23 in addition to the plural functional blocks included in the image interpretation report creating apparatus 1 as described above (FIG. 4) as functional blocks formed by a CPU 50 and software (program).

When a value relating to a medical condition is contained in the past report and/or report difference information, the graph display unit 23 allows the display unit 100 to display a graph showing an aged variation or change of the value relating to the medical condition in time sequence.

Next, the operation of the graph display unit 23 will be specifically explained.

When the report database 4a shown in FIG. 3 is stored in the image interpretation report server 4, the same type of examination is performed on the same part of the same patient three times in the past, and this examination is the fourth examination. When an image interpretation report on the fourth examination is created, as described above, the image interpretation reports (image interpretation reports of report IDs “000001”, “000005”, and “000069”) and the report difference information on the first to third examinations are loaded from the report database 4a, and the report progress list 40 and the finding entry screen 30 are displayed on the display unit 100 based on the loaded image interpretation reports and the report difference information on the first to third examinations.

At this time, the graph display unit 23 determines whether or not the values relating to the medical condition are contained in the image interpretation reports and/or report difference information on the first to third examinations. Here, the value “1 cm to 2 cm” representing the diameter of the tumor is contained in the finding of the image interpretation report on the first examination, the value “3 cm” representing the diameter of the tumor is contained in the image interpretation report and the report difference information on the second examination, and the value “4 cm” representing the diameter of the tumor is contained in the image interpretation report and the report difference information on the third examination. In this case, the graph display unit 23 allows the display unit 100 to display a graph display screen 60 for displaying a line graph with the horizontal direction as the number of examinations and the vertical direction as the length (the diameter of tumor).

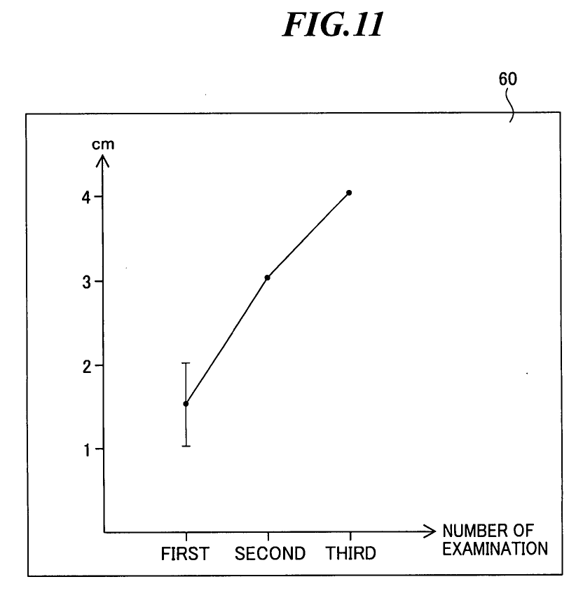

FIG. 11 shows an example of the graph display screen 60 displayed on the display unit 100. Here, in the image interpretation report on the first examination (in the image interpretation report of report ID “000001”), the value representing the diameter of the tumor has a range span of 1 cm in the phrase“1 cm to 2 cm”. Accordingly, the graph display unit 23 clearly shows that the value representing the diameter of the tumor within the image interpretation report on the first examination has the range span of 1 cm, that is, a range from 1 cm to 2 cm, and uses 1.5 cm as the center value thereof for plotting the line graph.

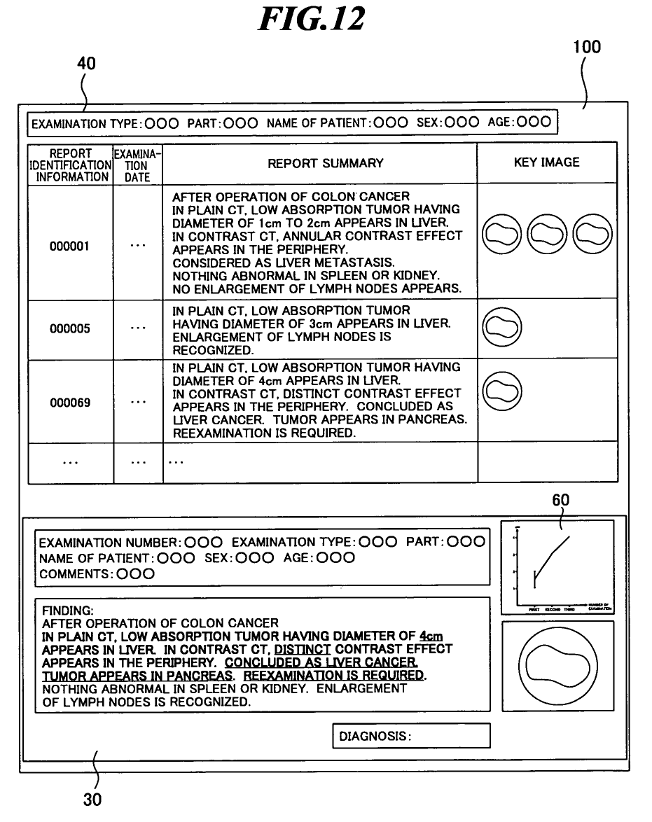

The graph display screen 60 may be displayed within the finding entry screen 30 as shown in FIG. 12. Further, a part or the entire of the graph display screen 60 may overlap the finding entry screen 30 and the report progress list 40. In this case, the screen displayed at the forefront can be switched according to the user's operation.

Further, when a save command of the image interpretation report on the fourth examination is inputted, the value on the medical condition (the diameter of the tumor) in the image interpretation report on the fourth examination may be additionally plotted in the graph.

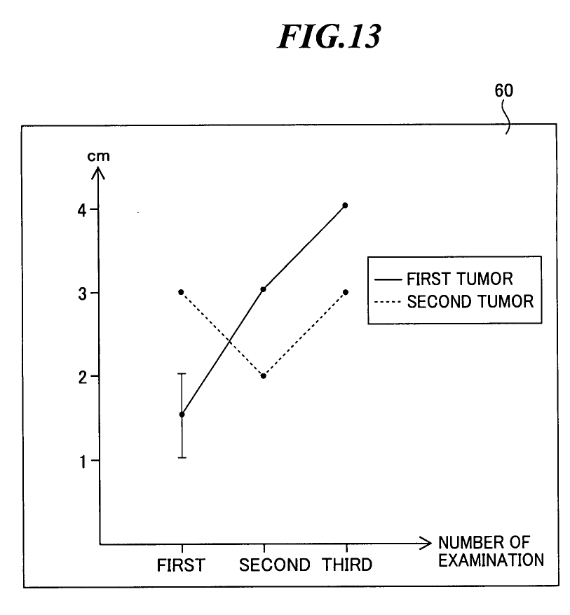

Here, the case where each of the past reports and/or report difference information contains a value on one medical condition (a diameter of one tumor) has been described. However, in the case where each of the past reports and/or report difference information contains plural values on two or more medical conditions, two or more graph display screens may be displayed, or two or more line graphs may be displayed within one graph display screen. For example, when each of the past reports and/or report difference information contains diameters of two tumors, the series of the diameter of the first tumor and the series of the diameter of the second tumor may be distinguishably displayed by indicating the diameter of the first tumor by the first line type (solid line, blue line or the like) and the diameter of the second tumor by the second line type (dotted line, red line or the like) in one graph display screen as shown in FIG. 13.

Further, when each of the past report and/or report difference information contains values on two or more medical conditions, the aged variation of the value on the medical condition selected by the user may be displayed. For example, when each of the past reports and/or report difference information contains diameters of two tumors, only the aged variation of one diameter of the tumor selected by the user may be displayed in a line graph.

Alternatively, the graph may be displayed only when the changed portion tag <CHANGED PORTION> to </CHANGED PORTION> is attached to the value on the medical condition in the past report difference information (FIG. 3), that is, only when the value on the medical condition is changed, while no graph may be displayed when each of the past reports contains the value on the medical condition but there is no change, for example, in the diameter of the tumor.

Here, the line graph is displayed within the graph display screen 60, however, other types of graphs (bar graph or the like) may be displayed. Alternatively, the change over age on the medical condition may be displayed not as a graph but as numerical values. For example, when the report database 4a shown in FIG. 3 is stored in the image interpretation report server 4, three values of “1 cm to 2 cm”, “3 cm” and “4 cm” may be sequentially displayed. In addition, differences between adjacent two values (here, the difference “+1 cm to +2 cm” between “1 cm to 2 cm” and “3 cm” and the difference “+1 cm” between “3 cm” and “4 cm”) may be further displayed.

As described above, according to the embodiment, when the value on the medical condition is contained in the past reports and/or report difference information, the user can visually recognize the series of the value on the medical condition, and easily grasp the change of the value on the medical condition. Thereby, it becomes easier to put the change of the value on the medical condition to good use in creating the image interpretation report on this examination.

1. An image interpretation support system for supporting creation of image interpretation reports based on medical images, said system comprising:
an image interpretation report server for storing a report database which accumulates difference information between past reports as image interpretation reports created in past on a same patient as that in this examination in association with the respective past reports; and
an image interpretation report creating apparatus connected to said image interpretation report server directly or via a network, said image interpretation report creating apparatus including:
follow-up observation examination determining means for determining whether or not this examination is an object of follow-up observation;
report finding control means for creating, when this examination is an object of follow-up observation, an image interpretation report at this time by generating an image interpretation report creation screen by utilizing at least one past report and the difference information on the at least one past report accumulated in said report database to cause a display unit to display the image interpretation report creation screen and entering information in the image interpretation report creation screen according to a user's operation;
changed portion extracting means for extracting a portion, which is changed between the image interpretation report creation screen in which the information is entered according to the user's operation and an image interpretation report creation screen generated by utilizing the at least one past report, to generate difference information; and
report saving means for storing the difference information generated by said changed portion extracting means in association with said image interpretation report at this time and the at least one past report in said report database.

2. An image interpretation support system according to claim 1, wherein said report finding control means generates the image interpretation report creation screen by utilizing the last report as the most recent one among the past reports on the same patient as that of this examination.

3. An image interpretation support system according to claim 2, wherein said report finding control means displays a finding text in the last report as a draft in the image interpretation report creation screen.

4. An image interpretation support system according to claim 3, wherein said report finding control means sets a format discriminative for a user to a portion, which is changed between the finding in the last report and the finding in an image interpretation report prior to the last report, in the draft displayed in the image interpretation report creation screen by utilizing the different information on the last report.

5. An image interpretation support system according to claim 1, wherein said report saving means saves the image interpretation report at this time only when the changed portion is extracted by said changed portion extracting means.

6. An image interpretation support system according to claim 1, wherein said changed portion extracting means extracts a sentence containing a different phrase by comparing the finding in the image interpretation report created at this time and the finding in the last report.

7. An image interpretation support system according to claim 1, wherein said changed portion extracting means extracts a sentence, which is changed from the finding in the last report, based on an operation history in creating the image interpretation report at this time.

8. An image interpretation support system according to claim 1, further comprising:
means for creating a list indicating portions, which are changed among the past reports, by utilizing the difference information stored in said report database.

9. An image interpretation support system according to claim 8, wherein said list indicates the portions, which are changed among the past reports, in time sequence.

10. An image interpretation support system according to claim 1, further comprising:
medical condition value display means for causing the display unit to display an aged variation of a value on a medical condition when the value on the medical condition is contained in the past reports and/or the difference information on the past reports accumulated in said report database.

11. An image interpretation support system according to claim 10, wherein said medical condition value display means causes the display unit to display the aged variation of the value on the medical condition as a graph.

12. An image interpretation support system according to claim 11, wherein said medical condition value display means causes, when plural values on medical conditions are contained in the past reports and/or the difference information on the past reports accumulated in said report database, the display unit to display the aged variation of at least one of the plural values on the medical conditions.

13. An image interpretation support system according to claim 12, wherein said medical condition value display means causes the display unit to display the aged variation of the plural values on the medical conditions by employing plural line types, respectively.

14. An image interpretation support system according to claim 12, wherein said medical condition value display means causes the display unit to display the aged variation of a value selected by the user from among the plural values on the medical conditions.
